(19) United States
(12) Patent Application Publication
(10) Pub. No.: US 2024/0351352 A1
(43) Pub. Date: Oct. 24, 2024

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: YOHEI KUSANO, Tokyo (JP); YUSUKE NAKAYA, Tokyo (JP); SHOICHI ZENSAI, Kanagawa (JP)

(21) Appl. No.: 18/638,093

(22) Filed: Apr. 17, 2024

(30) Foreign Application Priority Data
Apr. 18, 2023 (JP) 2023-068021

(51) Int. Cl. B41J 11/00; B41J 11/36

(52) U.S. Cl. CPC B41J 11/00222; B41J 11/36

(57) ABSTRACT

A printing apparatus includes a conveying unit configured to convey a print medium with respect to a printing unit configured to eject liquid, a drying unit provided downstream of the printing unit in a first direction and configured to dry the print medium, and a control unit configured to perform control such that, in a case where the print medium is conveyed in a second direction opposite to the first direction after the image on the print medium is passed through the drying unit by conveying in the first direction, a heat transfer amount from the drying unit to the print medium is smaller than a heat transfer amount from the drying unit to the print medium in a case where the print medium is conveyed in the first direction.

### BACKGROUND OF THE INVENTION

### Field of the Invention

The present invention relates to a printing apparatus that performs printing by ejecting liquid onto a print medium.

### Description of the Related Art

In an inkjet type recording apparatus, a configuration including a drying unit such as a heater or an air blowing mechanism for drying a recording medium onto which ink is ejected is known.

Furthermore, Japanese Patent Publication Laid-Open No. 2021-160089 discloses a recording apparatus in which a recording medium printed by a printing unit is conveyed in a forward direction and a reverse direction along a conveyance path to pass through a drying unit a plurality of times in order to accelerate drying of ink on the recording medium and to shorten the drying time.

In addition, Japanese Patent Publication Laid-Open No. 2006-225128 discloses an image forming apparatus that forms a mark at a position corresponding to an image formed on a long recording medium, conveys the long recording medium in a reverse direction, and controls to stop the conveyance of the long recording medium in the reverse direction by detecting the mark by a detection means.

However, in Japanese Patent Publication Laid-Open No. 2021-160089 and Japanese Patent Publication Laid-Open No. 2006-225128, when the recording medium is conveyed in the reverse direction along the conveyance path to be rewound, the amount of rewinding the recording medium becomes large in a long image pattern. In this case, there is a possibility that the recording medium to which the ink has been applied and which has been subjected to heating and drying reaches the position of the ink ejection head. For example, in the case of a recording medium on which printing has been performed at a high density, there is a possibility that volatile components of the warmed ink evaporate and condense on the head nozzle surface, and the ejection accuracy of the nozzles lowers thus adversely affecting the image quality.

### SUMMARY OF THE INVENTION

The present invention has been made in view of the above-described problems, and suppresses deterioration in image quality in a recording apparatus that performs rewinding of a recording medium.

According to a first aspect of the present invention, there is provided a printing apparatus comprising: a conveying unit configured to convey a print medium in a first direction and a second direction opposite to the first direction with respect to a printing unit configured to eject liquid and perform printing; a drying unit provided downstream of the printing unit in the first direction and configured to dry the print medium on which an image is printed; and a control unit configured to perform control such that, in a case where the print medium is conveyed in the second direction by the conveying unit after the image on the print medium is passed through the drying unit by conveying the print medium in the first direction by the conveying unit, a heat transfer amount from the drying unit to the print medium is smaller than a heat transfer amount from the drying unit to the print medium in a case where the print medium is conveyed in the first direction.

According to a second aspect of the present invention, there is provided a method for controlling a printing apparatus including a conveying unit configured to convey a print medium in a first direction and a second direction opposite to the first direction with respect to a printing unit configured to eject liquid and perform printing, and a drying unit provided downstream of the printing unit in the first direction and configured to dry the print medium on which an image is printed, the method comprising: performing control such that, in a case where the print medium is conveyed in the second direction by the conveying unit after the image on the print medium is passed through the drying unit by conveying the print medium in the first direction by the conveying unit, a heat transfer amount from the drying unit to the print medium is smaller than a heat transfer amount from the drying unit to the print medium in a case where the print medium is conveyed in the first direction.

Further features of the present invention will become apparent from the following description of exemplary embodiments with reference to the attached drawings.

### BRIEF DESCRIPTION OF THE DRAWINGS

FIG. 1 is a schematic cross-sectional diagram illustrating a configuration of a recording apparatus according to a first embodiment of the present invention.

FIG. 2 is a block diagram illustrating a configuration of a recording apparatus.

FIGS. 3A to 3C are a block diagram of a drying unit and schematic cross-sectional views in a paper width direction and a conveying direction.

FIGS. 4A and 4B are a block diagram of a cooling unit and a schematic cross-sectional view in a paper width direction.

FIGS. 5A to 5C are diagrams illustrating a conveying state of a recording paper in a forward direction.

FIGS. 6A and 6B are diagrams illustrating a conveying state of a recording paper in a reverse direction.

FIG. 7 is a cross-sectional view of a drying unit according to a second embodiment.

FIGS. 8A to 8C are diagrams illustrating a conveyance state of a recording paper in a forward direction according to a third embodiment.

FIGS. 9A and 9B are diagrams illustrating a conveyance state of a recording paper in a reverse direction according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

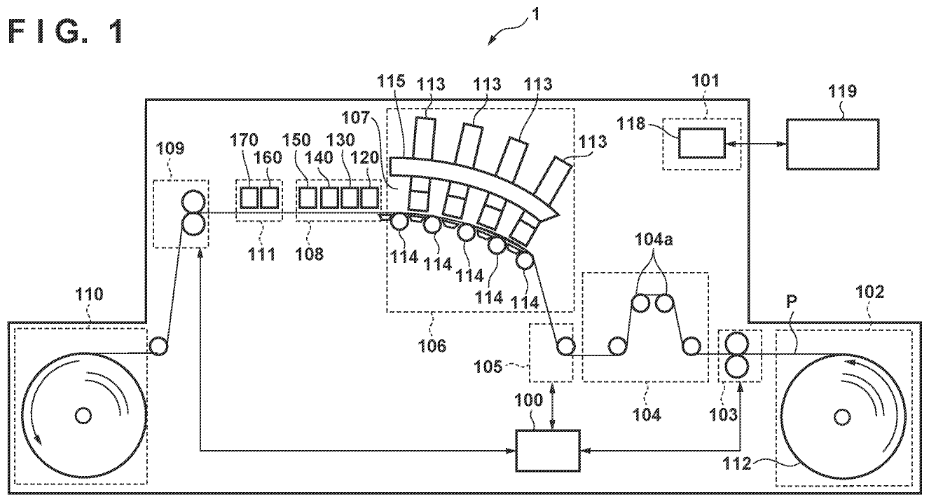

First, in FIG. 1, an upper side in the plane of drawing is defined as an upper side, a right side to a left side is defined as a recording paper conveying direction, and a near side to a far side of the plane of drawing orthogonal to the recording paper conveying direction is defined as a recording paper width direction. The recording apparatus 1 of the present example is a high-speed line printer using continuous recording paper wound in a roll shape. For example, it is suitable for a field of printing of mass printing in a print laboratory or the like.

FIG. 1 is a schematic cross-sectional diagram illustrating an internal configuration of a recording apparatus 1. The recording apparatus according to the present embodiment interiorly includes units of a recording paper supply unit 102, a first conveyance roller pair 103, a skew feeding correction unit 104, a tension detection unit 105, a recording unit 106, a drying unit 108, a cooling unit 111, a second conveyance roller pair 109, a recording paper collecting unit 110, and a control unit 101. The recording paper is conveyed along a recording paper conveyance path indicated by a solid line P in the drawing, and is processed by each unit. Here, the conveyance of the continuous recording paper from the recording paper supply unit 102 to the recording paper collecting unit 110 is defined as forward direction conveyance, and the reverse thereof is defined as reverse direction conveyance.

The recording paper supply unit 102 is a unit for holding and supplying a sheet-like continuous recording paper wound in a roll shape. The recording paper supply unit 102 is configured to accommodate a roll 112, and pull out and supply the recording paper. Note that the number of accommodatable rolls is not limited to one, and two or three or more rolls may be accommodated, and the recording paper may be selectively pulled out and supplied. In addition, the recording paper is not limited to being wound in a roll shape as long as the recording paper is continuous. For example, a continuous recording paper provided with perforations for each unit length may be folded back for each perforation to be stacked and accommodated in the recording paper supply unit 102. Note that the recording paper supply unit 102 is independently rotationally controlled by a drive motor (not illustrated) so as to be forward rotatable and reverse rotatable.

The first conveyance roller pair 103 is a unit that feeds a recording paper to the meandering correction unit 104, the tension detection unit 105, the recording unit 106, and the drying unit 108 arranged in the following order along the conveyance path P, and applies tension to the recording paper between the first conveyance roller pair 103 and the second conveyance roller pair 109. The first conveyance roller pair 103 is rotated by driving a motor (not illustrated) to perform tension conveyance.

The meandering correction unit 104 is a unit for correcting meander in the width direction of the recording paper at the time of tension conveyance of the recording paper. The meandering correcting unit 104 includes a meandering correction roller 104a and a meander detection sensor (not shown) that detects meandering of the recording paper. The meandering correction roller 104a can change the inclination of the recording paper in the conveying direction by a motor (not shown), and corrects the meander of the recording paper based on the measurement of the meander detection sensor. At this time, the function of correcting meandering can be enhanced as the recording paper is wound around the meandering correction roller 104a.

The tension detection unit 105 is a unit for detecting tension when the recording paper is tension conveyed between the first conveyance roller pair 103 and the second conveyance roller pair 109.

The recording unit 106 is a recording paper processing unit that forms an image by performing a recording process on the conveyed recording paper with the recording head 113 from the upper side. The conveyance path P in the recording unit 106 is formed by a guide roller 114 arranged in an arc shape that is convex upward, and a constant tension is applied to the recording paper so that a clearance between the recording paper and the recording head 113 is secured. A plurality of recording heads 113 are arranged along the conveying direction so as to form an arc shape following the conveyance path P. In this example, four line type recording heads corresponding to four colors of Bk (black), Y (yellow), M (magenta), and C (cyan) are provided. That is, each recording head 113 has nozzles (ejection ports) for ejecting ink over a length corresponding to the width of the recording paper. Note that the number of colors and the number of recording heads 113 are not limited to four. The plurality of recording heads 113 are integrally held by a head holder 115, and the head holder 115 is movable in the up-down direction so that a clearance between the recording paper and the recording heads 113 can be changed. As the inkjet method, a method using a heat generating element, a method using a piezoelectric element, a method using an electrostatic element, a method using a MEMS element, and the like can be adopted. Ink of each color is supplied from an ink tank (not shown) to the recording head 113 via an ink tube. Note that the present invention is not limited to a line type recording head, and can also be applied to a serial type recording head that performs recording by reciprocating in a width direction of a recording paper.

The drying unit 108 is a unit that is disposed on the downstream side in the conveying direction of the recording paper than the recording unit 106, reduces liquid contained in the ink applied on the recording paper by the recording unit 106, and enhances the fixability between the recording paper and the ink. The drying unit 108 heats the recording paper on which recording has been performed to dry the applied ink. In the drying unit 108, hot air is applied to the passing recording paper from at least the upper surface side to dry the ink-applied surface. In addition to the method of applying hot air, the drying method may be configured by combining a method of irradiating the surface of the recording paper with electromagnetic waves (ultraviolet rays, infrared rays, or the like) and a conductive heat transfer method by contact of a heat generating body.

The cooling unit 111 is a unit that cools the recording paper heated by the drying unit 108, and suppresses heat accumulation in the roll and adhesion of the ink to the surface of the conveyance roller that comes into contact with the ink on the recording paper in the recording paper collecting unit 110 on the downstream side in the conveying direction. In the cooling unit 111, air is blown to the recording paper from the printing surface side to cool the printing surface side. The air at the time of cooling is configured to blow air having a desired wind speed from the outside of the recording apparatus 1 to the recording paper by a fan or the like via a duct (not illustrated). Regarding the temperature of the air, air having a temperature lower than the outside air temperature of the apparatus 1 may be blown using a heat exchanger.

The second conveyance roller pair 109 is a unit that conveys the recording paper while applying tension with the first conveyance roller pair 103 to adjust the tension of the recording paper. The second conveyance roller pair 109 is rotated by being driven by a motor (not illustrated), and the tension of the recording paper is adjusted by a clutch (not illustrated) that can control a drive-coupled torque described later by the tension control unit 100 according to the tension value detected by the tension detection unit 105. As an additional configuration for adjusting the tension of the recording paper, a configuration for controlling the speed of the second conveyance roller pair 109 by the tension detection unit 105 may be added. As a tension control method in this case, there are two methods of a torque control method of controlling the torque value transmitted from the clutch and a speed control method of controlling the roller speed of the second conveyance roller pair, and the tension control method can be switched according to the purpose or both methods can be used at the same time.

The recording paper collecting unit 110 is a unit for winding the recording paper, subjected to the recording process, around a winding core. The number of rolls that can be collected is not limited to one, and two or three or more winding cores may be provided, and recording paper may be collected by selectively switching between two or three or more winding cores. Depending on the processing content after recording, the continuous recording paper may be cut using a cutter and the cut recording paper may be stacked instead of being wound around the winding core.

Note that the recording paper collecting unit 110 is independently rotationally controlled by a drive motor (not illustrated) so as to be forward rotatable and reverse rotatable.

The recording paper S is conveyed in the forward direction and conveyed in the reverse direction by performing forward rotation control or reverse rotation control of drive motors (not illustrated) of the recording paper supply unit 102 and the recording paper collecting unit 110, respectively.

In the case of the reverse direction conveyance as well, the tension conveyance is performed between the first conveyance roller pair 103 and the second conveyance roller pair 109 similarly to the forward direction conveyance.

A control unit 101 is a unit that controls each unit of the entire recording apparatus. The control unit 101 includes a CPU, a storage device, a controller including various control units, an external interface, and an operation unit 118 with which a user performs input and output. The operation of the recording apparatus 1 is controlled based on a command from a controller or a host PC 119 such as a host computer connected to the controller via the external interface.

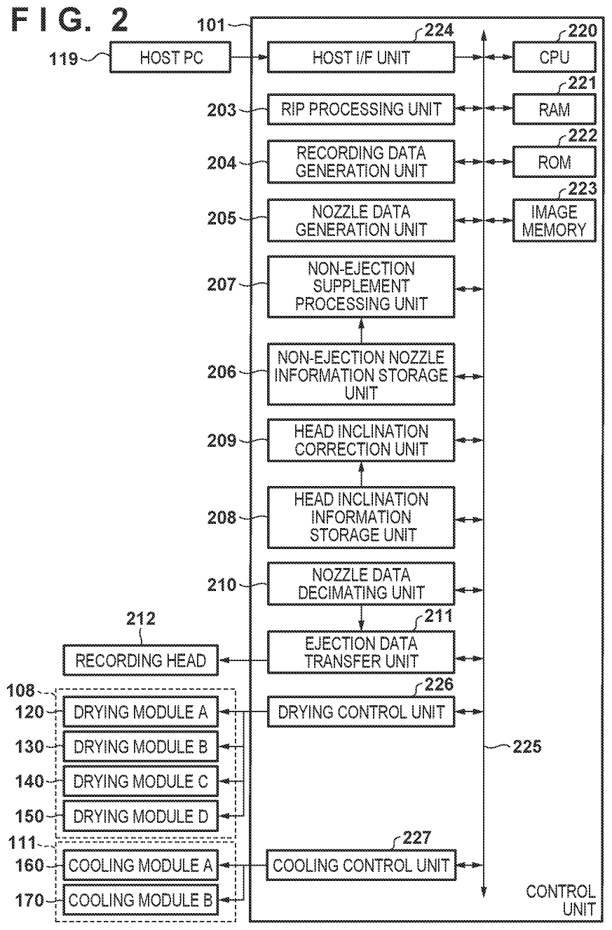

In FIG. 2, a control unit that performs data flow process of the recording apparatus in the present embodiment will be described. The control unit 101 includes a host I/F unit 224. Print data input from the host PC 119 via the host I/F unit 224 is rendered by the RIP processing unit 203 and becomes multi-valued bitmap data. The print data input here is, for example, a page description language (PDL)). The multi-valued bitmap data is subjected to ink color conversion and quantization process in the recording data generation unit 204, and becomes halftone data of the ink color. The halftone data is assigned to each nozzle by the nozzle data generation unit 205 for each color, and becomes nozzle data (binary data) of the number of nozzles for each line. In the above description, for nozzle data, a non-ejection supplement process (process of reassigning ejection data assigned to a non-ejection nozzle to a nozzle other than the non-ejection nozzle) is performed by a non-ejection supplement processing unit 207 according to the non-ejection nozzle information stored in a non-ejection nozzle information storage unit 206. The nozzle data subjected to the non-ejection supplement process is performed with a head inclination correction (correction of moving data in the conveying direction in accordance with the inclination amount) by a head inclination correction unit 209 according to the head inclination information stored in the head inclination information storage unit 208. The nozzle data subjected to the head inclination correction in this manner is stored in an image memory 223. The CPU 220 transfers the nozzle data stored in the image memory 223 to a nozzle data decimating unit 210. The transferred nozzle data after the inclination correction is subjected to decimating process by the nozzle data decimating unit 210, and transferred to the recording head 212 by the ejection data transfer unit 211. In addition, the CPU 220 performs control on each unit described above. This control is executed based on a control program stored in the ROM 222. The control program stored in the ROM 222 includes an operating system (OS) for performing time-division control in units of load module referred to as a task by a system clock. A RAM 221 is used as the working area of the CPU 220. Each unit including the CPU 220 is connected to the system bus 225.

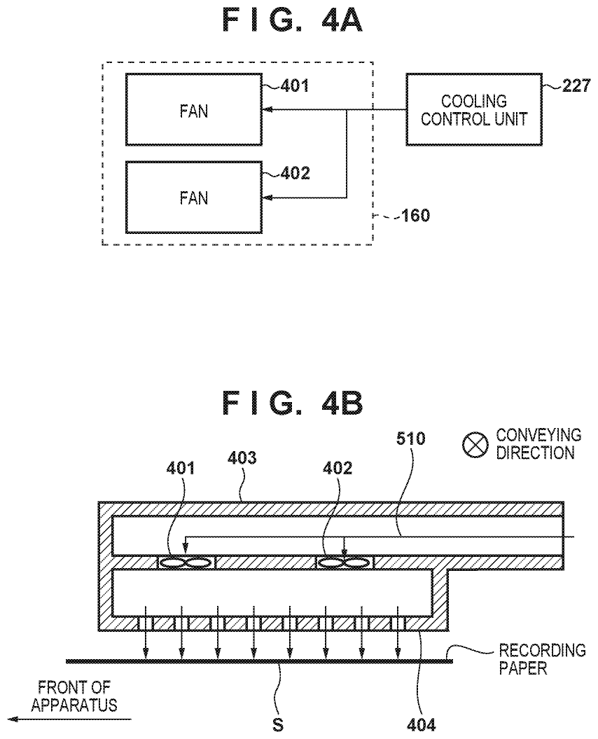

The control unit 101 includes a drying control unit 226, and performs temperature control of a drying module A120, a drying module B130, a drying module C140, and a drying module D150, and the like. In addition, whether or not each drying module is normal can be determined by polling (periodic inquiry) or whether or not a normal temperature is returned. Furthermore, the cooling control unit 227 is provided to control the rotation number of fans 401 and 402 (FIGS. 4A, 4B) of a cooling module A160 and a cooling module B170. It is possible to determine whether each fan is rotating normally by an encoder unit (not illustrated) in the fans 401 and 402 or a detection means that detects a lock (rotation failure) of the fan.

### <Configuration of Drying Unit 108>

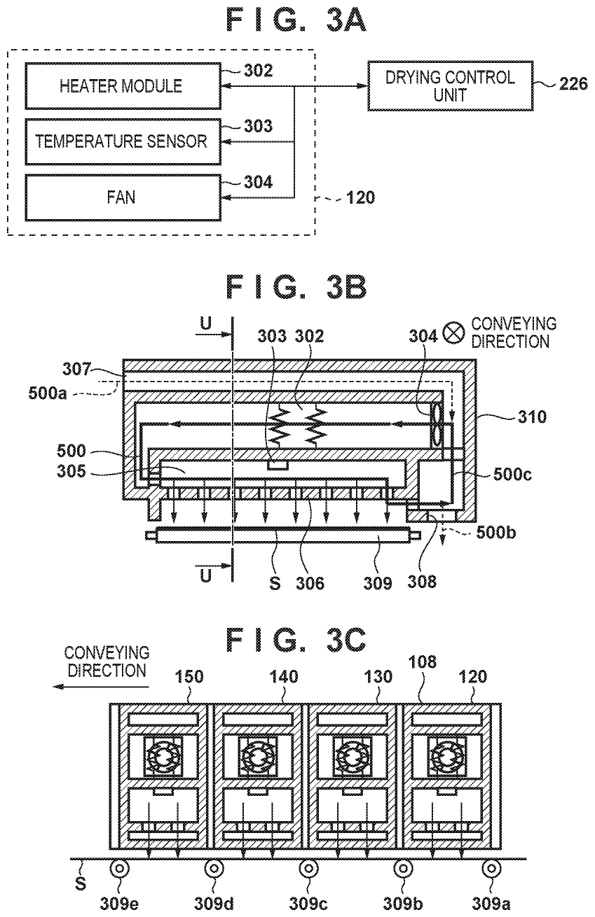

FIG. 3A is a diagram illustrating a configuration in the drying module A120 as an example. The drying module A120 includes a heater module 302 as heating means, a temperature sensor 303, and a fan 304 for blowing warm air. The drying control unit 226 receives information on the target temperature from the CPU 220. The drying control unit 226 sets the heater module 302 to ON/OFF based on the warm air temperature in the duct 305 to be measured of the temperature sensor 303. However, the ON/OFF state is repeated according to the DUTY ratio instead of the ON/OFF state. For example, when the target temperature is 70° C. and the warm air temperature in the duct 305 obtained from the temperature sensor 303 is 60° C., the DUTY ratio of the heater module 302 is controlled to 100% or the like so as to increase the warm air temperature. When the warm air temperature in the duct 305 exceeds 70° C., the DUTY ratio of the heater module 302 is controlled to 10% or the like so as to lower the warm air temperature. This value is merely an example and is variable. FIG. 3B is a schematic cross-sectional view of the drying module A120 in the paper width direction, and is a view seen from the paper conveying direction. The air passage formed by the frame 310 is provided with the heater module 302 and the fan 304, so that the air heated by the heater module 302 is blown onto the recording paper S on the conveyance path P via the nozzle portion 306 as indicated by a thick solid line 500 in the drawing as warm air. The frame 310 is provided with an intake portion (intake port) 307 that introduces outside air and an exhaust portion (exhaust port) 308 that is used for drying the recording paper S and exhausts air with increased humidity by a desired amount.

The warm air circulating configuration will be described with reference to FIG. 3B. A thick solid line 500 in the drawing indicates a basic warm air circulation path in the duct 305. The warm air circulating system is adopted in order to effectively utilize the thermal energy acting on the air from the heater module 302 and to shorten the start-up time until a desired temperature is reached when starting to use the apparatus. The outside air 500a (broken line in the drawing) taken in from the intake portion 307 is drawn in by the fan 304. A part of the dried air 500b (broken line in the drawing) is exhausted from the exhaust portion 308 to the outside of the apparatus. The 500c which is not exhausted is taken in again by the fan 304 and is circulated.

FIG. 3C is a cross-sectional view of the drying unit 108 taken along a cutting line U-U illustrated in FIG. 3B in the conveying direction. The drying module A120, the drying module B130, the drying module C140, and the drying module D150 are arranged side by side in the conveying direction. On the opposite side of the recording paper S, backup rollers 309a to 309e are disposed so that the recording paper is not excessively separated from the drying unit when warm air is applied.

### <Configuration of Cooling Unit 111>

FIG. 4A is a diagram illustrating, as an example, a configuration of the inside of cooling module A160, similarly to the drying module of FIG. 3A to 3C. The cooling module A160 includes fans 401 and 402. FIG. 4B is a schematic cross-sectional view of the cooling module A160 in the paper width direction, and is a view seen from the paper conveying direction. The air passage formed by the duct 403 is provided with the fans 401 and 402, so that air is blown onto the recording paper S on the conveyance path P via the nozzle portion 404 as indicated by an arrow 510 in the drawing.

### <Reverse Direction Conveyance Control>

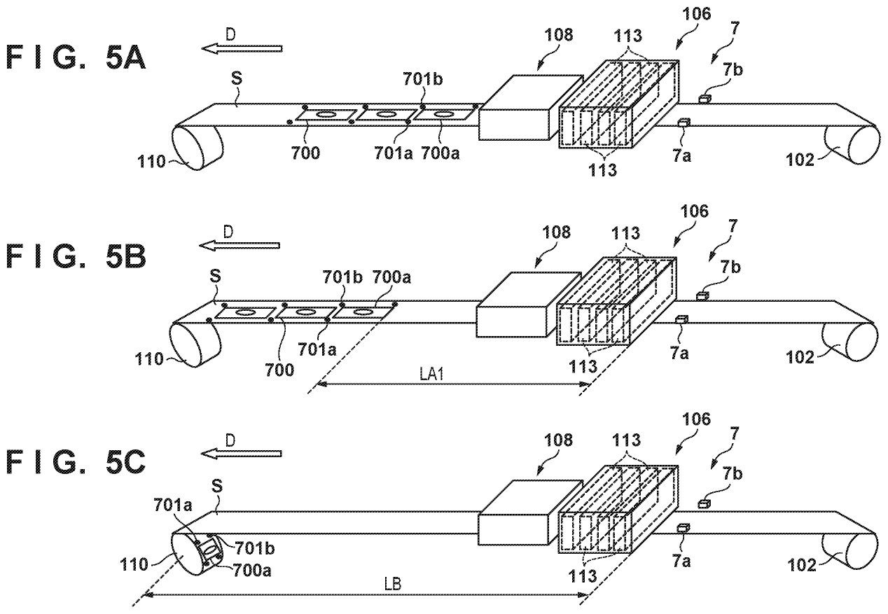

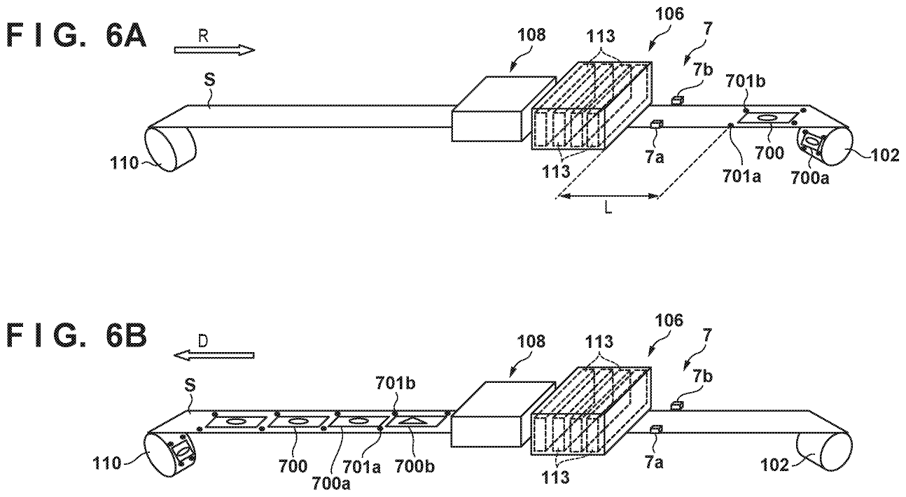

Next, the reverse direction conveyance control of the recording paper supply unit 102 and the recording paper collecting unit 110 will be described with reference to FIGS. 5A to 5C and FIGS. 6A and 6B. FIG. 5A is a diagram illustrating a printing state of the forward direction conveyance, and FIG. 5B is a diagram illustrating a state when the printing in the forward direction conveyance is interrupted. FIG. 5C is a diagram illustrating a state when printing in the forward direction conveyance is resumed. FIG. 6A is a view illustrating a state in which the winding in the reverse direction conveyance is interrupted, and FIG. 6B is a diagram illustrating a state in which the printing in the forward direction conveyance is resumed.

As illustrated in FIG. 5A, image 700 is continuously printed by the recording unit 106 while forward direction conveying the recording paper S in the direction of an arrow D. Mark images 701a and 701b are printed at predetermined positions on both sides in the width direction of the image 700, for example, diagonal positions (one position is on the downstream side in the width direction, and the other position is on the upstream side in the width direction). Mark sensors 7a and 7b for detecting the mark images 701a and 701b, respectively, are provided on the upstream side of the recording unit 106 and at positions facing both side ends in the width direction of the recording paper S. The image 700 and the mark images 701a and 701b printed by the recording unit 106 are passed through the drying unit 108 to be dried and fixed.

As illustrated in FIG. 5B, when the control unit 101 stops printing during continuous printing in the direction of the arrow D, printing by the recording unit 106 is immediately stopped, but the recording paper S is stopped after deceleration. Note that printing of the final image 700a to be printed on the recording paper S by the recording unit 106 is stopped in a state where all the images of the image data have been printed.

A space from the final image 700a to the recording unit 106 is blank paper over a length corresponding to the deceleration period. Note that this blank paper portion varies depending on the length corresponding to the printing speed, and for example, when it takes 10 seconds to stop at a printing speed of 60 m/min, the length is about 10 m. This length is defined as LA1 (m).

As illustrated in FIG. 5C, the known printing apparatus that handles roll paper is configured to start printing again in this state, and the length from the upstream side of the blank paper portion LA1 (m) until the conveyance speed is stabilized to resume printing is further required. This length is defined as LA2 (m). Therefore, the total LB (m) of the blank paper portion LA1 (m) and the length LA2 (m) corresponding to the acceleration until the conveyance speed is stabilized to resume printing is a waste paper.

On the other hand, in the recording apparatus 1 according to the present embodiment, as illustrated in FIG. 6A, the recording paper S is rewound in the direction of an arrow R by inputting a print resume signal to the control unit 101. Specifically, the drive motors of the recording paper supply unit 102 and the recording paper collecting unit 110 are controlled, the recording paper supply unit 102 and the recording paper collecting unit 110 are reverse rotated, and the recording paper S is conveyed in the reverse direction in the direction of the arrow R.

At the time of reverse direction conveyance of the recording paper S, the final image 700a printed before stopping and each image 700 on the downstream side are passed through the recording unit 106 and are conveyed to the upstream side. At this time, the final image 700a that has passed through the recording unit 106 in the reverse direction and the mark images 701a and 701b printed at predetermined positions on both sides in the width direction of the image 700 are detected by the mark sensors 7a and 7b. Then, the number of passed mark images 701a and 701b is counted.

Specifically, at the time of reverse direction conveyance of the recording paper S, the number of mark images 701a and 701b detected by the mark sensors 7a and 7b and corresponding to the amount of reverse direction conveyance is input to the control unit 101. At this time, each mark image 701a on the downstream side in the width direction is detected by one mark sensor 7a, and each mark image 701b on the upstream side in the width direction is detected by the other mark sensor 7b. At the time of reverse direction conveyance, the mark image 701b on the upstream side in the width direction is detected by the mark sensor 7b to detect the reverse direction terminating end portion of one image 700, and the mark image 701a on the downstream side in the width direction is detected by the mark sensor 7a to detect the reverse direction leading end portion of one image 700.

In addition to the length by which the final image 700a passes, the length by which the recording paper S is conveyed in the reverse direction is excessively rewound by the length of the sheet length L (m) in consideration of the acceleration of the conveyance speed when the recording paper S is conveyed in the forward direction and the meandering stability.

After the recording paper S is conveyed in the reverse direction over the predetermined length as described above, the control unit 101 performs the operation of the forward direction conveyance, so that the recording paper S is conveyed in the forward direction while accelerating.

As illustrated in FIG. 6B, the number of images forward direction conveyed in the direction of the arrow Dis counted by detecting the mark images 701a and 701b attached to the image 700 by the mark sensors 7a and 7b. When the count matches the count for reverse direction conveyance, it means that the final image 700a has passed through the recording unit 106. Then, printing of the new image 700b is started by the recording unit 106.

As illustrated in FIG. 6A, at the time point of resuming the printing, the sheet length L (m) of the distance for obtaining sufficient acceleration time is unwound, and thus the traveling speed of the recording paper S at the time of resuming the printing illustrated in FIG. 6B reaches the predetermined printing speed. As a result, the printing can be resumed from the position following the final image 700a before stopping with accurate positional accuracy in the conveying direction.

Note that, in the present embodiment, an example has been described in which the reverse direction conveyance control of the recording paper S is performed by the mark images 701a and 701b and the mark sensors 7a and 7b, but the present invention is not limited thereto. For example, punch holes may be provided instead of mark images at both end portions of the image 700, and the number of punch holes may be counted to perform the reverse direction conveyance control of the recording paper S.

### <Reverse Direction Conveyance Control of Drying Unit>

Next, the reverse direction conveyance control of the drying unit 108 will be described with reference to FIGS. 3A to 3C, FIGS. 5A to 5C, and FIGS. 6A and 6B.

As illustrated in FIGS. 5A to 5C, in the case of forward direction conveyance, the image printed on the recording paper S is dried and fixed by passing through the drying unit 108. Here, when the reverse direction conveyance control is performed by the control unit 101, the recording paper S passes through the drying unit 108 again.

As illustrated in FIGS. 3A to 3C, in the drying unit 108, the air heated by passing through the heater module 302 is blown onto the recording paper S from the nozzle portion 306. Here, in a case where the drying unit 108 is controlled to perform the same operation as that in the forward direction conveyance, the recording paper S is heated again by the heated air even in the reverse direction conveyance.

As illustrated in FIG. 6A, when the conveying direction of the recording paper S is reversed, the recording paper S reheated by drying unit 108 passes through recording unit 106. At this time, the reheated recording paper S increases the ambient temperature under the recording head, and dew condensation may occur on the nozzle surface of the recording head 113 on which the nozzles are formed. When dew condensation occurs on the nozzle surface, the ejection accuracy from the nozzle may lower, leading to deterioration of image quality.

Therefore, in the present embodiment, in order to prevent the recording paper S from being reheated at the time of the reverse direction conveyance, the air volume of the fan 304 is reduced such that the amount of heat transfer per unit time to the recording paper S is controlled to be smaller at the time of the reverse direction conveyance than at the time of the forward direction conveyance. As a result, reheating of the recording paper S by the drying unit 108 can be suppressed at the time of the reverse direction conveyance. That is, the temperature of the recording paper S conveyed to below the recording head can be prevented from rising, and deterioration of image quality due to dew condensation can be suppressed.

In the present embodiment, the example in which the air volume of the fan 304 is reduced at the time of the reverse direction conveyance has been described, but the method of controlling the amount of heat transfer per unit time to the recording paper S to be smaller at the time of the reverse direction conveyance than at the time of the forward direction conveyance is not limited thereto.

For example, the rotation of the fan 304 may be completely stopped to stop the air blown onto the recording paper S from the nozzle portion 306. Alternatively, the temperature adjustment of the heater module 302 may be controlled so that the temperature of the air blown from the nozzle portion 306 may be controlled to be low (e.g., 60° C.). Alternatively, the output of the heater module 302 may be stopped, and the temperature of the air blown from the nozzle portion 306 may be controlled to be the same as the outside air. Alternatively, at the time of reverse direction conveyance, the conveyance speed may be increased by increasing the output of the drive motor of each of the recording paper supply unit 102 and the recording paper collecting unit 110, and the passage time of the recording paper S through the drying unit 108 may be shortened. Furthermore, in the first embodiment, the description has been given on the assumption that the recording apparatus 1 includes the cooling unit 111, but the present invention is also applicable to a configuration that does not include the cooling unit 111.

### Second Embodiment

Next, a second embodiment of the reverse direction conveyance control of the drying unit 108 will be described with reference to FIGS. 5A to 5C, FIGS. 6A and 6B, and FIG. 7. Note that, in the following description, since the overall configuration of the recording apparatus is similar to that of the first embodiment, the same portions are denoted by the same reference numerals, and description thereof will be omitted as appropriate.

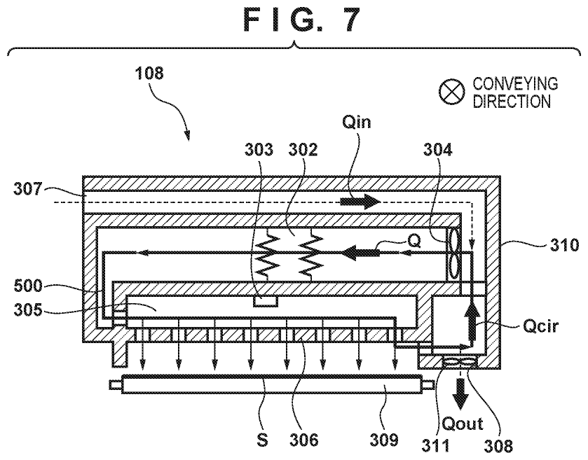

FIG. 7 is a cross-sectional view of the drying unit 108 according to the second embodiment. As illustrated in FIG. 7, in the second embodiment, an exhaust fan 311 is added in the vicinity of the inlet of the exhaust portion 308 as compared with the configuration of FIGS. 3A to 3C, which is the first embodiment.

With reference to FIG. 7, a method of suppressing the temperature rise of the fan 304 serving as an air blowing means in the drying unit 108 will be described. The flow rate of air blown by the fan 304 is represented by Q [m³/min]. The air blown by the fan 304 moves along a warm air circulation path indicated by a thick solid line 500 in FIG. 7. In this case, warm air at a flow rate Qout [m³/min] is exhausted from the exhaust portion 308 by the exhaust fan 311, and air at a flow rate Qcir [m³/min] returns to the fan 304. In addition, the outside air at a flow rate Qin [m³/min] taken in from the intake portion 307 by the fan 304 is mixed with the warm air at the flow rate Qcir. As a result, the relationship between the flow rates in the system of the circulation flow path is approximately represented by (Equation 1).

$$Q = Qcir + Qin = Qcir + Qout \qquad ( Equation 1 )$$

That is, if the exhaust amount of the exhaust fan 311 is set to be larger at the time of the reverse direction conveyance of the recording paper S than at the time of the forward direction conveyance of the recording paper S, the intake amount of the outside air can be increased without changing the flow rate Q of the fan 304 serving as the air blowing means, and the temperature rise in the drying unit 108 can be suppressed. The present invention is not limited to this, and the same effect can be obtained by changing the flow rates of the fan 304 and the exhaust fan 311 together. For example, it is also effective to stop the fan 304. Since the temperature rise in the drying unit 108 is suppressed, the temperature of the air blown from the nozzle portion 306 to the recording paper S can also be lowered as compared with the time of forward direction conveyance of the recording paper S.

Accordingly, reheating of the recording paper S when passing through the drying unit 108 at the time of the reverse direction conveyance can be prevented, and the temperature of the recording paper S when being conveyed to below the recording head 113 can be prevented from rising. Therefore, deterioration in image quality due to the occurrence of dew condensation on the nozzle surface can be suppressed.

In the second embodiment, the exhaust fan 311 is added to the vicinity of the inlet of the exhaust portion 308 to increase the intake amount of the outside air at the time of the reverse direction conveyance, but the present invention is not limited to this configuration. For example, an intake fan may be added to the vicinity of the inlet of the intake portion 307 to increase the intake amount of the outside air at the time of the reverse direction conveyance. Such a method can also suppress the temperature rise in the drying unit 108. The second embodiment is also applicable to the recording apparatus 1 that does not include the cooling unit 111.

### Third Embodiment

Next, a third embodiment of the reverse direction conveyance control of the drying unit 108 will be described. Note that, in the following description, since the overall configuration of the recording apparatus is similar to that of the first embodiment, the same portions are denoted by the same reference numerals, and description thereof will be omitted as appropriate.

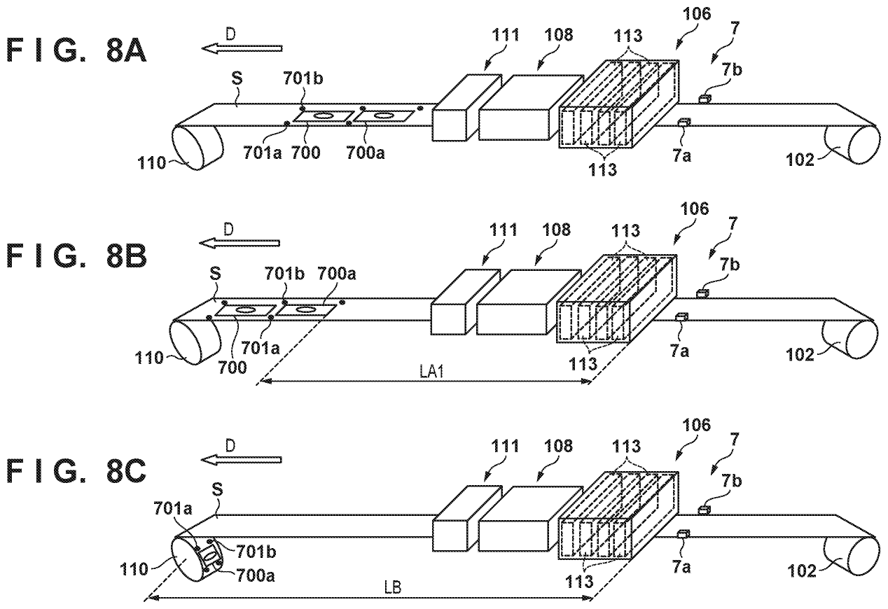

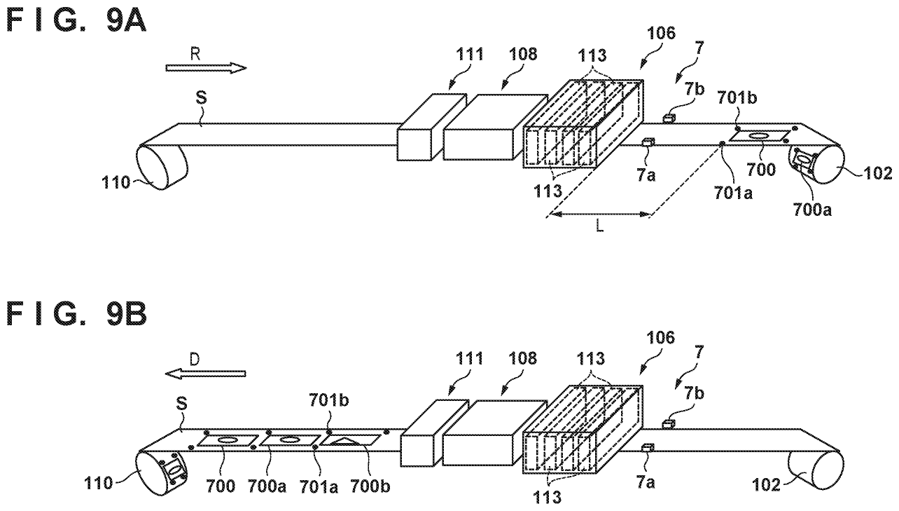

FIG. 8A is a diagram illustrating a printing state in the forward direction conveyance according to the third embodiment. FIG. 8B is a diagram illustrating a state in which printing in the forward direction conveyance is interrupted. FIG. 8C is also a diagram illustrating a state in which printing in the forward direction conveyance is interrupted. FIG. 9A is a diagram illustrating a state in which winding in the reverse direction conveyance is interrupted. FIG. 9B is a diagram illustrating a state in which printing in the forward direction conveyance is resumed.

In the third embodiment, as illustrated in FIGS. 8A to 8C and FIGS. 9A and 9B, the cooling unit 111 on the downstream side of the drying unit 108 is controlled.

As illustrated in FIG. 8A, image 700 is continuously printed by the recording unit 106 while forward direction conveying the recording paper S in the direction of the arrow D. Mark images 701a and 701b are printed at predetermined positions on both sides in the width direction of the image 700. Mark sensors 7a and 7b for detecting the mark images 701a and 701b, respectively, are provided on the upstream side of the recording unit 106 and at positions facing both side ends in the width direction of the recording paper S.

The image 700 printed by the recording unit 106 is passed through the drying unit 108 to be dried and fixed. At this time, the recording paper S is heated by the heated air in the drying unit 108.

The cooling unit 111 is a unit that cools the recording paper heated by the drying unit 108, and suppresses heat accumulation in the roll and adhesion of the ink to the surface of the conveyance roller that comes into contact with the ink on the recording paper in the recording paper collecting unit 110 on the downstream side in the conveying direction.

As illustrated in FIG. 8B, when the control unit 101 stops printing during continuous printing in the direction of the arrow D, printing by the recording unit 106 is immediately stopped, but the recording paper S is stopped after deceleration. Note that printing of the final image 700a to be printed on the recording paper S by the recording unit 106 is stopped in a state where all the images of the image data have been printed.

A space from the final image 700a to the recording unit 106 is blank paper over a length corresponding to the deceleration period. This length is defined as LA1 (m).

As illustrated in FIG. 8C, the known printing apparatus that handles roll paper is configured to resume printing in this state, and the length from the upstream side of the blank paper portion LA1 (m) until the conveyance speed is stabilized to resume printing is further required. This length is defined as LA2 (m). Therefore, the total LB (m) of the blank paper portion LA1 (m) and the length LA2 (m) corresponding to the acceleration until the conveyance speed is stabilized to resume printing is a waste paper.

On the other hand, in the recording apparatus 1 according to the present embodiment, as illustrated in FIG. 9A, the recording paper S is rewound in the direction of the arrow R by inputting a print resume signal to the control unit 101. Specifically, the drive motors of the recording paper supply unit 102 and the recording paper collecting unit 110 are controlled, the recording paper supply unit 102 and the recording paper collecting unit 110 are reverse rotated, and the recording paper S is conveyed in the reverse direction in the direction of the arrow R.

At the time of reverse direction conveyance of the recording paper S, the final image 700a printed before stopping and each image 700 on the downstream side are passed through the recording unit 106 and are conveyed to the upstream side. At this time, the final image 700a that has passed through the recording unit 106 in the reverse direction and the mark images 701a and 701b printed at predetermined positions on both sides in the width direction of the image 700 are detected by the mark sensors 7a and 7b. Then, the number of passed mark images 701a and 701b is counted. The recording paper S is cooled by the cooling unit 111 by the reverse direction conveyance, but in a case where the cooling is insufficient, the recording paper S may be reheated by the drying unit 108.

Therefore, in the present embodiment, at the time of the reverse direction conveyance, the outputs of the fans 401 and 402 in the cooling module A160 are increased to increase the amount of air blown from the nozzle portion 404 to the recording paper S.

As a result, the temperature of the recording paper S can be lowered to the vicinity of the outside air temperature, and reheating of the recording paper S can be suppressed even if the recording paper S is passed through the drying unit 108 at the time of the reverse direction conveyance. Then, by suppressing the temperature of the recording paper S conveyed to below the recording head 113 to be low, deterioration of image quality due to the occurrence of dew condensation on the nozzle surface can be suppressed.

In the present embodiment, the case where the recording paper S is cooled by the air blown from the nozzle portion 404 of the cooling unit 111 has been described, but the present invention is not limited thereto. For example, the conveyance roller may have a cooling function such as air cooling or water cooling, and the recording paper S may be brought into direct contact with the conveyance roller to be cooled. In addition, the cooling unit 111 may be used in combination to assist cooling.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-068021, filed Apr. 18, 2023, which is hereby incorporated by reference herein in its entirety.

What is claimed is:

1. A printing apparatus comprising:
a conveying unit configured to convey a print medium in a first direction and a second direction opposite to the first direction with respect to a printing unit configured to eject liquid and perform printing;
a drying unit provided downstream of the printing unit in the first direction and configured to dry the print medium on which an image is printed; and
a control unit configured to perform control such that,
in a case where the print medium is conveyed in the second direction by the conveying unit after the image on the print medium is passed through the drying unit by conveying the print medium in the first direction by the conveying unit, a heat transfer amount from the drying unit to the print medium is smaller than a heat transfer amount from the drying unit to the print medium in a case where the print medium is conveyed in the first direction.

2. The printing apparatus according to claim 1, wherein the drying unit includes a heating unit configured to heat air and an air blowing unit configured to blow the heated air to the print medium.

3. The printing apparatus according to claim 2, wherein the control unit controls the air blowing unit such that in a case where the print medium is conveyed in the second direction by the conveying unit, an air volume blown from the drying unit to the print medium is smaller than an air volume blown in a case where the print medium is conveyed in the first direction.

4. The printing apparatus according to claim 3, wherein the control unit stops the air blowing unit in a case where the print medium is conveyed in the second direction by the conveying unit.

5. The printing apparatus according to claim 2, wherein the control unit controls the heating unit such that, in a case where the print medium is conveyed in the second direction by the conveying unit, a temperature of air blown from the drying unit to the print medium is lower than a temperature in a case where the print medium is conveyed in the first direction.

6. The printing apparatus according to claim 2, wherein the drying unit includes an exhaust port configured to exhaust air to the outside, and
the control unit controls the air blowing unit such that, in a case where the print medium is conveyed in the second direction by the conveying unit, an exhaust amount of the exhaust port is larger than an exhaust amount in a case where the print medium is conveyed in the first direction.

7. The printing apparatus according to claim 2, wherein the drying unit includes an intake port configured to take in air from the outside, and
the control unit controls the air blowing unit such that, in a case where the print medium is conveyed in the second direction by the conveying unit, an intake amount of the intake port is larger than an intake amount in a case where the print medium is conveyed in the first direction.

8. The printing apparatus according to claim 2, wherein
the control unit controls the conveying unit such that, in a case where the print medium is conveyed in the second direction by the conveying unit, a speed at which the conveying unit conveys the print medium is faster than a speed in a case where the print medium is conveyed in the first direction.

9. The printing apparatus according to claim 1, further comprising a cooling unit provided downstream of the drying unit in the first direction and configured to cool the print medium that has passed through the drying unit.

10. The printing apparatus according to claim 9, wherein
the cooling unit includes a second air blowing unit configured to blow air to the print medium, and
the control unit controls the cooling unit such that, in a case where the print medium is conveyed in the second direction by the conveying unit, an air volume of the second air blowing unit is larger than an air volume of the second air blowing unit in a case where the print medium is conveyed in the first direction.

11. A method for controlling a printing apparatus including a conveying unit configured to convey a print medium in a first direction and a second direction opposite to the first direction with respect to a printing unit configured to eject liquid and perform printing, and a drying unit provided downstream of the printing unit in the first direction and configured to dry the print medium on which an image is printed, the method comprising:
performing control such that, in a case where the print medium is conveyed in the second direction by the conveying unit after the image on the print medium is passed through the drying unit by conveying the print medium in the first direction by the conveying unit, a heat transfer amount from the drying unit to the print medium is smaller than a heat transfer amount from the drying unit to the print medium in a case where the print medium is conveyed in the first direction.

12. A non-transitory computer readable storage medium storing a program for causing a computer to execute a method for controlling a printing apparatus including a conveying unit configured to convey a print medium in a first direction and a second direction opposite to the first direction with respect to a printing unit configured to eject liquid and perform printing, and a drying unit provided downstream of the printing unit in the first direction and configured to dry the print medium on which an image is printed, the method comprising:
performing control such that, in a case where the print medium is conveyed in the second direction by the conveying unit after the image on the print medium is passed through the drying unit by conveying the print medium in the first direction by the conveying unit, a heat transfer amount from the drying unit to the print medium is smaller than a heat transfer amount from the drying unit to the print medium in a case where the print medium is conveyed in the first direction.
